(19) United States
(12) Patent Application Publication
(10) Pub. No.: US 2026/0359205 A1
(43) Pub. Date: Nov. 12, 2026

(54) SYSTEM SCREENING VIA WORKLOAD CHARACTERIZATION

(71) Applicants: Garrett Clay, Beaverton, OR (US); Scott Petersen, Tualatin, OR (US); Marcos E. Carranza, Portland, OR (US); Bryan Hunt, McCall, ID (US)

(72) Inventors: Garrett Clay, Beaverton, OR (US); Scott Petersen, Tualatin, OR (US); Marcos E. Carranza, Portland, OR (US); Bryan Hunt, McCall, ID (US)

(21) Appl. No.: 19/721,973

(22) Filed: Jun. 26, 2026

(51) Int. Cl. G06F 11/3668; G06F 11/34; G06F 21/55

(52) U.S. Cl. CPC G06F 11/3688; G06F 11/3442; G06F 21/556

(57) ABSTRACT

Various aspects of optimizing silicon device screening and related test processes are described. In an example, profiling actions are configured to monitor a workload executing in a computing system and to collect telemetry data describing usage of hardware-defined blocks of the circuitry, such as instruction mix, spatial coverage, and execution-driven operating behavior. Based on the telemetry data, the usage of the hardware-defined blocks invoked during execution of the workload is measured. The measured usage is distilled into a workload embedding that represents the hardware usage patterns without exposing proprietary workload code or data. The workload embedding is output to provide a hardware usage measurement specific to the workload. The embedding can be compared by similarity to other embeddings and used to select test workloads that exercise the blocks the workload used, allocating screening effort to match observed behavior, thus reducing screening time and cost while maintaining coverage.

### BACKGROUND

Processors and other computer hardware units integrate numerous functional units, often referred to as intellectual property (IP) blocks, within a single device or platform. These hardware units may include processor cores, vector and matrix execution units, arithmetic logic units, floating point units, branch predictors, cache hierarchies, memory controllers, on-die and off-die interconnects, and interfaces to peripheral and memory expansion devices. Each unit implements a portion of the overall functionality of the device and is exercised to a different degree depending on the instructions and data that a given workload presents to the hardware during execution.

To verify that such devices function according to their specifications, manufacturers and system integrators may apply “silicon screening” or “screening” tests at various stages of a product life cycle, including at pre-production validation, high-volume manufacturing, and in-fleet operation stages. Screening tests exercise the hardware using defined sequences of instructions and operating conditions to observe whether the device responds as expected. These screening tests can distinguish parts of the device that operate correctly from those that do not. Screening tests are typically organized into test suites that contain large quantities of test content and are executed under time and resource constraints, since test execution consumes equipment time and incurs cost.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate, generally, by way of example, but not by way of limitation, various embodiments discussed in the present document.

FIG. 1A and FIG. 1B illustrate schematic diagrams of example screening arrangements applied to a system.

FIG. 2 illustrates a flowchart of an example workload characterization method.

FIG. 3 illustrates a component diagram of an example workload-informed screening system.

FIG. 4A and FIG. 4B illustrate graphical charts of example system usage in connection with a workload-informed screening system.

FIG. 5 illustrates a component diagram of an example workload profiling arrangement implemented within a system.

FIG. 6 depicts a flowchart of an example method for generating and using a workload characterization with a workload embedding.

FIG. 7A provides an overview of example components deployed at a computing device.

FIG. 7B provides a further overview of example components within a computing device.

### DETAILED DESCRIPTION

The following discusses improvements for the testing and validation of computer hardware, including the use of federated screening approaches to analyze computer processor hardware. Some of the approaches include selecting and configuring screening tests for a hardware device based on a characterization of how a particular workload uses the hardware. Some of these approaches include generating a representation of hardware usage from telemetry collected during execution of a workload and applying the representation to control test selection, allocation of screening effort among hardware blocks, and operating conditions under which screening is performed. In an example, this representation is a workload embedding that includes, for example, a vector of normalized feature-weight pairs derived from telemetry measurements across instruction mix, hardware units utilization, and operating conditions.

During the execution of screening tests, the behavior of a workload on a system can be observed through telemetry collected from hardware and software sources. Such sources include but are not limited to performance monitoring counters integrated into the processor, resource utilization monitors that report cache occupancy and memory bandwidth, and operating system facilities that report events relating to instruction execution, system calls, memory access, and device activity. Telemetry of this type characterizes attributes such as the mix of executed instructions, the extent to which individual hardware units are used, and the voltage, frequency, temperature, and power conditions induced during execution.

Computer hardware devices are commonly deployed in secure data center environments operated by parties distinct from the device manufacturer, where the software workloads executed on the hardware devices may be subject to confidentiality constraints. These confidentiality constraints can limit the extent to which the device manufacturer receives information describing the workloads executed on a particular deployed system. As a result, many approaches for screening of hardware devices proceed without any information or context of how real-world workloads actually exercise the hardware devices. In contrast, the present approaches allow screening to account for observed hardware usage while limiting exposure of confidential information describing the workloads.

The following discloses various methods, devices, systems, and machine-readable medium instructions to adapt the screening of a computer hardware system to the expected behavior of workloads executed on that system. This adaptation may be performed by characterizing how a workload exercises the different hardware components of the system, and using that characterization to guide the selection and configuration of various screening tests.

In some examples, telemetry describing execution of a workload is collected from one or more sources, such as performance monitoring counters, resource utilization monitors, and operating system event interfaces, while the workload runs on a system. The collected telemetry may describe attributes such as the mix of instruction classes executed, the extent to which individual hardware blocks are exercised, and operating conditions such as voltage, frequency, temperature, and power consumed during execution, as well as how these attributes vary over time. This collected telemetry is distilled into a compact representation, referred to in some examples as an embedding, that reflects relative hardware usage patterns, while omitting confidential information describing the underlying software. The embedding may then be used to drive screening decisions, such as: selecting test content that exercises instruction classes and hardware blocks in proportion to observed usage, allocating screening effort among hardware blocks according to their relative utilization, and configuring operating conditions under which screening is performed to correspond to conditions observed during execution of the workload.

In some examples, an embedding for a given workload can be compared against previously stored embeddings using a similarity operation, allowing a new workload to be associated with a screening configuration developed for a similar previous workload. In some implementations, the embedding is generated and retained within a boundary associated with a party that operates the system, and a further abstracted version of the embedding may be produced for use outside that boundary. The same characterization approach can also be applied to a screening test itself. This characterization allows the manner in which a scripted test exercises the hardware to be compared to the manner in which an actual workload exercises the hardware. Based on this comparison, the test can be adjusted so that its behavior corresponds more closely to that of the workload.

Many screening attempts rely on broad, one-size-fits-all test suites that do not measure which parts of the microarchitecture are actually exercised. This results in long, expensive screening cycles that often over-emphasize the testing of features that individual customers do not use in real-world, production settings. Tests that are not informed by actual customer workload behavior routinely over-screen overlapping functionality or low-usage functionality. This wastes significant time and money across validation and manufacturing, or may even prevent exhaustive testing of the functionality that matters to an actual client.

Although real customer workloads can be used to provide the insight needed to focus testing operations, those workloads are proprietary, kept secret, or are unable to be shared directly with silicon manufacturers. This leaves silicon manufacturers and system integration screening teams unable to identify true usage patterns, causing screening tests to be locked into inefficient, redundant testing processes that waste resources and incur high costs.

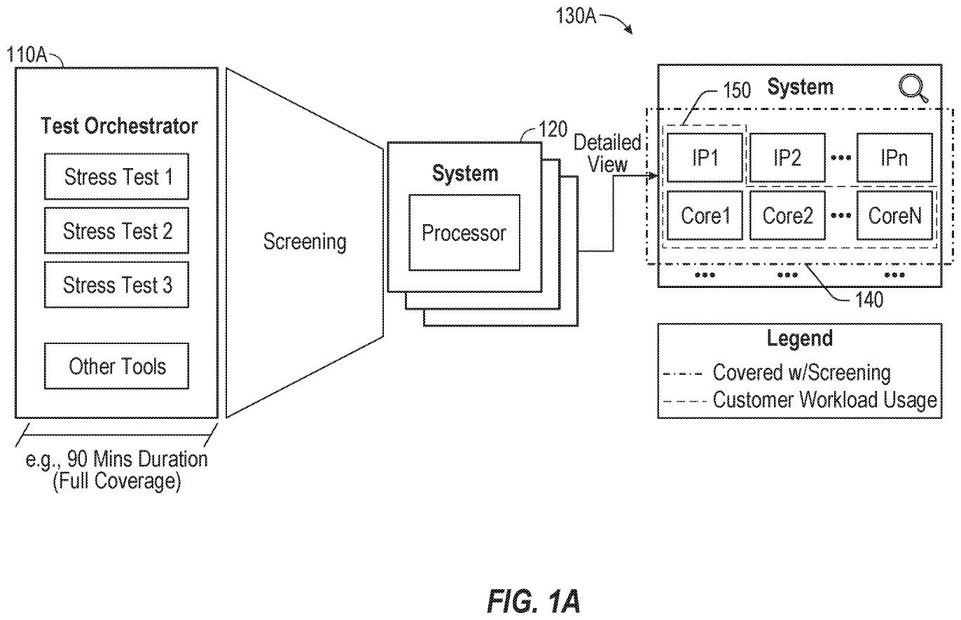

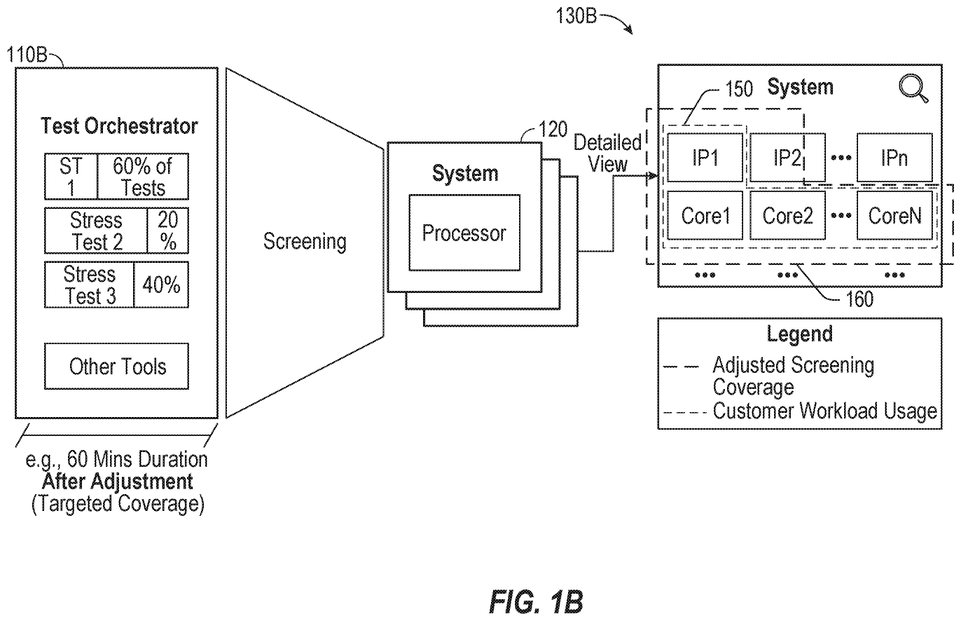

FIG. 1A illustrates a schematic diagram of an example screening arrangement applied to a computer system before workload-informed adjustment. A test tool set 110A (e.g., provided by a test orchestrator) provides a set of stress tests, shown as Stress Test 1, Stress Test 2, and Stress Test 3, together with other tools, which are applied in a screening operation to a system 120. The system 120 depicted includes a semiconductor device (specifically, a processor), but the particular hardware being tested with the screening tests may be deployed across many devices or device systems on a large scale.

A detailed view of the system 120 shows a set of components arranged within the system, including a first IP block IP1, a second IP block IP2, through an nth IP block IPn, and a set of cores including Core1, Core2, through CoreN. In the detailed view 130A depicted in FIG. 1A, a first boundary 140 indicates the components covered by the screening operation performed using the test tool set 110A, and a second boundary 150 indicates the individual components of the system that are actually exercised by a customer workload.

In FIG. 1A, the first boundary 140, corresponding to planned screening coverage, encompasses many or all components within the system 120 at a system level, while the second boundary 150, corresponding to actual customer workload usage, encompasses a reduced subset of those components. The test tool set 110A is associated with a test duration, shown as an example of approximately 90 minutes, representing that a full test coverage of the components within the system 120 can be performed with a particular combination of the stress tests and tools in approximately 90 minutes.

FIG. 1B illustrates a schematic diagram of the example screening arrangement of FIG. 1A, applying workload-informed adjustment. A detailed view 130B of the system 120 shows the same components as the detailed view 130A, including the first IP block IP1 through the nth IP block IPn and the cores Core1 through CoreN. Similar to FIG. 1A, a test tool set 110B is applied as a screening operation to the system 120. However, the test tool set 110B is adjusted so that the stress tests are allocated in reduced proportions of the hardware components actually used in the system 120. This means that stress testing can be accomplished by executing only 60 percent, 20 percent, and 40 percent of the available tests in the test tool set 110B.

In the detailed view 130B, a first boundary 160 indicates an adjusted screening coverage, and the second boundary 150 continues to indicate the customer workload usage. The screening coverage in FIG. 1B is adjusted (reduced) to directly or indirectly correspond to the components within the customer workload usage boundary. The reduced number or type of these stress tests is accomplished with targeted coverage, so that tests are not unnecessarily executed on IP blocks or hardware components not used by customer workloads. The test duration of the test tool set 110B can be reduced accordingly, as shown with an example of approximately 60 minutes. This results in a reduced time (as compared with test tool set 110A) to perform a targeted screening coverage of the components exercised by the customer workload, during three different stress tests.

Many types of testing and verification approaches use broad, generalized silicon screening, based on comprehensive test suites that are applied uniformly across components to maximize overall coverage. Screening execution in some settings may involve use of internal manufacturing data, such as historical failures, yield learning, and generalized risk areas, to improve cost and throughput efficiency. As shown in FIG. 1A, this approach sometimes may not account for actual customer workloads. The present framework provides an improved test selection and coverage that is informed by real workload usage patterns, on the basis of instruction mix, IP block utilization, operating conditions, or other effects. The present framework also provides an approach for customizing screening to customer workloads, while addressing a variety of IP and security constraints. As a result, this framework addresses many of the challenges from conservative, one-size-fits-all coverage and may prevent the over-screening of low-usage features.

This workload-directed approach to silicon screening can be accomplished by characterizing how real customer workloads exercise the microarchitecture, without exposing proprietary workload code. Instead of relying on uniform, one-size-fits-all test suites, the present approaches capture instruction mix, spatial IP block utilization, and execution-driven operating conditions from representative systems. This data is distilled into compact, IP-safe workload embeddings that reflect true hardware usage.

As shown in the examples below, workload embeddings are transformed into actionable screening recipes. Test selection, IP block stress allocation, and voltage/frequency/thermal conditions are automatically weighted to mirror real workload behavior rather than static worst-case assumptions. This enables precise, workload-aligned screening that increases stress on heavily used microarchitectural features while reducing redundant testing of rarely exercised paths. By decoupling workload insight from workload disclosure and enabling reuse of workload fingerprints across screening engagements, these approaches provide a secure and scalable mechanism to reduce screening time and cost while maintaining quality with workload-informed, microarchitecture-aware validation.

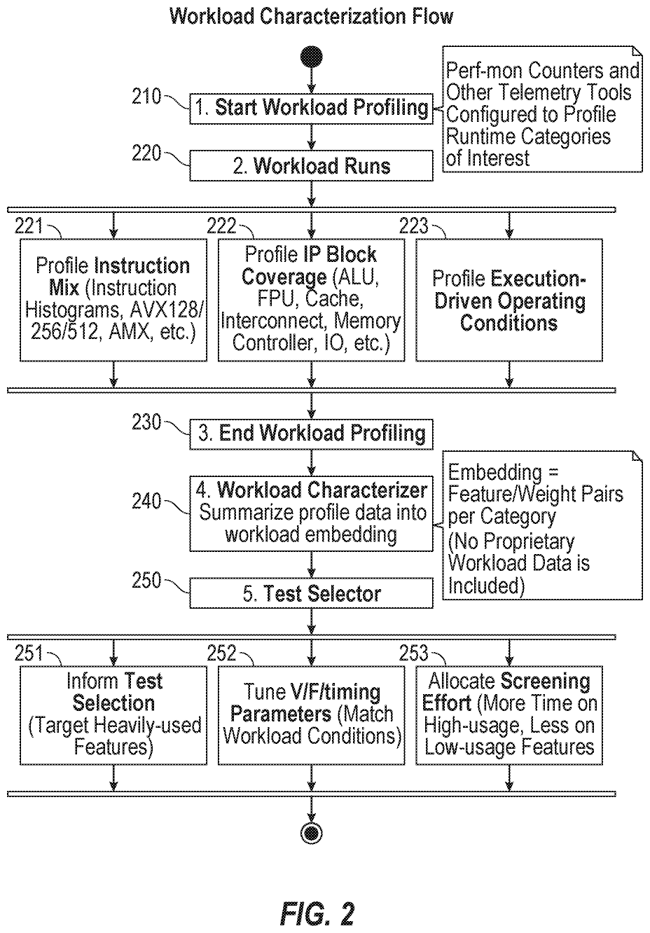

FIG. 2 illustrates a flowchart of an example workload characterization method. The workload characterization method begins with a workload profiling phase, proceeds through characterization of the collected profiling data into a workload embedding, and concludes by applying the workload embedding to drive screening decisions.

At operation 210, the workload profiling is started. In some examples, performance monitoring counters and other telemetry sources are configured to profile categories of runtime behavior of interest prior to or upon initiation of profiling. Operation 210 may include initialization operations such as associating the profiling with a workload to be observed and subscribing to events provided by an operating system and its interfaces.

At operation 220, the workload executes. The workload executes on a system while the configured telemetry sources observe its behavior. In some examples, the workload that runs at operation 220 is a customer workload, whereas in other examples, the workload is a screening test provided by a manufacturer, integrator, system validator, or other external interested party whose hardware coverage is profiled.

Operations 221, 222, and 223 are performed during the execution of the workload and represent categories of profiling that may be carried out concurrently (or, in parallel, conditionally, or sequentially). At operation 221, an instruction mix is profiled, characterizing which classes of architectural instructions are executed and their relative frequencies. For example, for a CPU hardware device, this can include collecting instruction histograms reflecting usage of instruction categories such as a specific instruction set (e.g., the Advanced Vector Extensions (AVX) instruction set, such as one or more of AVX128, AVX256, AVX512, and AMX SIMD extensions to the x86 instruction set architecture).

At operation 222, IP block coverage is profiled, characterizing which microarchitectural blocks and platform components are exercised and the extent of their usage. This may include, for example, arithmetic logic units (ALUs), floating point units (FPUs), caches, interconnects, memory controllers, input/output devices, and the like.

At operation 223, execution-driven operating conditions are profiled, characterizing how the workload exercises the hardware over time and the resulting operating conditions. This may include, for example, utilization dynamics, duty cycles, burstiness, sequencing of operations, and associated voltage, frequency, temperature, and power responses.

At operation 230, the workload profiling ends. The workload executes to its final state, a final snapshot of profiling information is collected, and resources allocated for profiling are released. In some examples, operation 230 includes capturing metadata describing hardware, firmware, and software versions and configurations together with the profiling data.

At operation 240, a workload characterizer summarizes the profiling data into a workload embedding. In some examples, the embedding comprises feature and weight pairs for one or more of the profiled categories and omits information describing the workload itself, so that proprietary workload data is not included in the embedding.

At operation 250, a test selector receives the workload embedding and applies it to drive screening decisions. Operations 251, 252, and 253 represent screening decisions that may be derived from the workload embedding at operation 250.

At operation 251, test selection is informed by the workload embedding so that test content targeting heavily used features is selected in proportion to the observed usage.

At operation 252, voltage, frequency, and timing parameters are tuned to correspond to operating conditions observed during execution of the workload.

At operation 253, screening effort is allocated among hardware blocks, so that a greater amount of screening is directed toward more heavily used blocks and a lesser amount toward less heavily used blocks.

A number of technical benefits and operational advantages are potentially provided by the presently disclosed workload characterization and test customization operations. A first potential advantage is precise and targeted screening. Workload-informed recipes dynamically focus screening effort on the device under test, increasing stress on heavily used microarchitectural features and reducing time on the rarely exercised features. The present approaches, therefore, emphasize specific technical changes to operating settings such as tuning voltage, frequency, timing, and instruction selection.

A second potential advantage is improved screening coverage feedback. Profiling test workloads provides insight into instruction usage, IP block coverage (spatial), and execution behavior over time (temporal). A third potential advantage is secure and confidential workload sharing. Customers can share workload profiles (not workloads) with a test harness, with reduced IP or security leak risk since the confidential data will not leave the system under test. Finally, a fourth potential advantage is operational expense and resource usage reduction. Workload-informed recipes reduce screening time, execution, and resource usage, while keeping quality at the same level of full coverage screening.

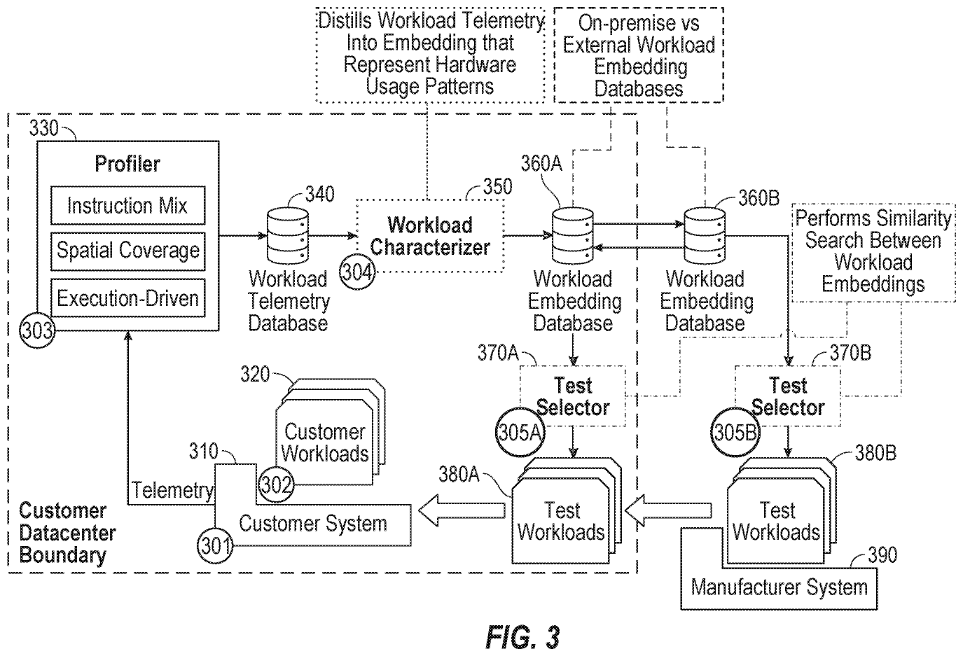

FIG. 3 illustrates a component diagram of an example workload-informed screening system. The system is depicted with respect to a customer datacenter boundary, shown as a dashed line, that separates components residing within a customer environment from components residing outside that environment. In some examples, the following operations of FIG. 3 correspond to the operations in the workload characterization method of FIG. 2.

The customer system 310 starts workload profiling at operation 301 and runs one or more customer workloads 320 at operation 302. As the customer workloads 320 execute on the customer system 310, telemetry describing execution of the customer workloads 320 is collected and provided to a profiler 330 located within the customer environment. The profiler 330 profiles categories of runtime behavior at operation 303. This can include tracking the instruction mix, spatial coverage, and execution-driven operating conditions of the workload (e.g., as corresponding to operations 221, 222, and 223 of FIG. 2). The profiler 330 stores the collected telemetry in a workload telemetry database 340 within the customer environment.

At operation 304, a workload characterizer 350 receives the telemetry from the workload telemetry database 340 and transforms the telemetry into a workload embedding that represents hardware usage patterns (e.g., as corresponding to operation 240 of FIG. 2). The workload embedding generated by the workload characterizer 350 is stored in a workload embedding database 360A located within the customer environment.

In some examples, the same or a further abstracted form of the workload embedding is provided to a workload embedding database 360B located outside the customer environment. The two databases may synchronize embeddings as indicated by the arrows between the workload embedding database 360A and the workload embedding database 360B.

At operation 305A, a test selector 370A receives a workload embedding from the workload embedding database 360A and uses the workload embedding to drive screening decisions. The test selector 370A selects and configures test workloads 380A to be applied to the customer system 310 for further screening operations on the same hardware.

Similarly, at operation 305B, a test selector 370B located outside the customer environment can receive a workload embedding from the workload embedding database 360B and use the workload embedding to drive screening decisions at the manufacturer system. This can include the selection and configuration of test workloads 380B, to be applied to a manufacturer system 390 for further screening operations with similar hardware. This use of the test selector 370B and the manufacturer system 390, outside the customer datacenter boundary, shows how workload embeddings generated by a customer can be used to drive screening performed by another party, while preventing the leakage or sharing of confidential information from the customer workloads 320.

Heterogeneous workload characterizations that span different types of hardware use cases and resources (e.g., cores, memory subsystems, IO devices, etc.) may be established with the techniques herein. As a first example, consider an instruction mix characterization with utilization measurements. This characterization classifies which architectural instructions are executed by a workload and their relative frequencies over time. This includes both ISA-level instruction categories and the mapping of these instruction categories to underlying microarchitectural execution resources. The instruction mix provides a logical view of workload behavior, independent of where instructions execute physically within the core.

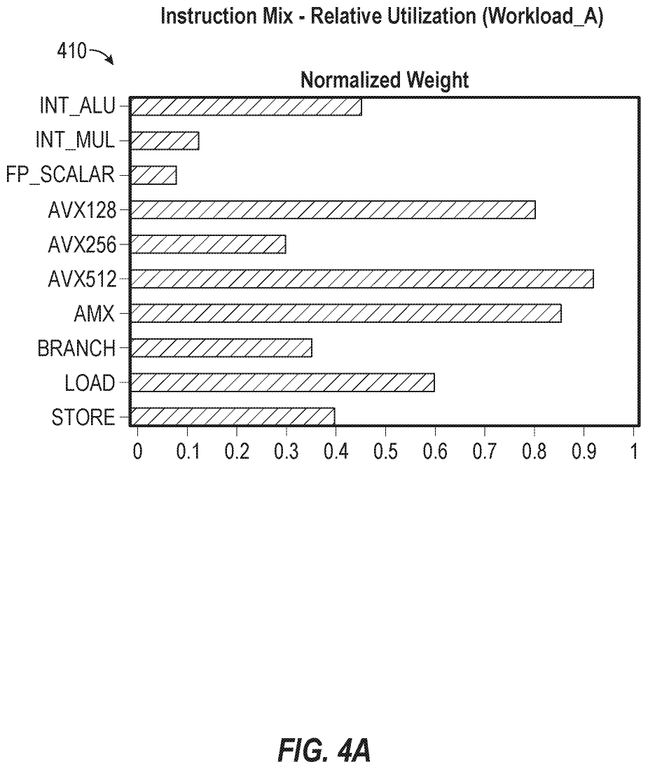

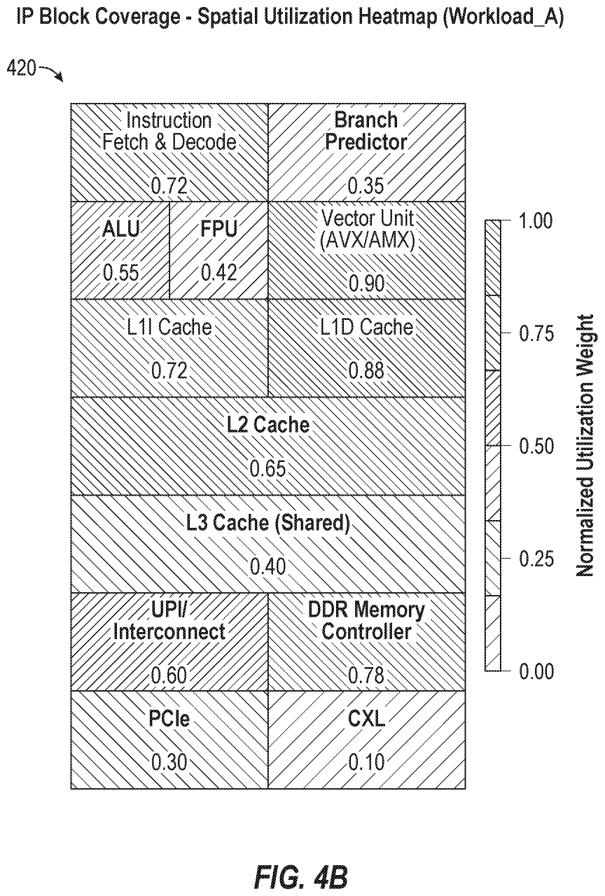

FIG. 4A illustrates a bar chart 410 of an example instruction mix representing normalized instruction utilization observed during a workload profiling window. The instruction mix in this bar chart 410 characterizes the classes of architectural instructions that are executed by a particular workload and their relative utilization over the profiling window.

The bar chart 410 depicts a set of bars, each corresponding to a class of instruction, plotted against a normalized weight axis ranging from 0 to 1. The length of each bar indicates the relative utilization intensity observed for the corresponding instruction class during the profiling window. The depicted instruction mix includes a class of integer arithmetic logic unit instructions (INT_ALU), a class of integer multiply instructions (INT_MUL), a class of scalar floating point instructions (FP_SCALAR), a class of 128-bit vector instructions (AVX128), a class of 256-bit vector instructions (AVX256), a class of 512-bit vector instructions (AVX512), a class of matrix instructions (AMX), a class of branch instructions (BRANCH), a class of load instructions (LOAD), and a class of store instructions (STORE).

The weights of the instruction mix provide a logical view of workload behavior that is independent of the physical locations within a processor at which the corresponding instructions execute. In some examples, the instruction mix is collected during execution of a workload, for example at operation 221 of FIG. 2, and forms a portion of a workload embedding generated by a workload characterizer, for example at operation 240 of FIG. 2.

In some examples, the weights of the instruction mix are subsequently applied by a test selector, for example, at operation 251 of FIG. 2, to select test content that exercises instruction classes in proportion to their respective weights. This enables test content exercising instruction classes associated with higher weights (e.g., the 512-bit vector instructions and the matrix instructions in the example of FIG. 4A) to be selected in a greater proportion than test content exercising instruction classes associated with lower weights. The particular instruction classes and weights depicted in FIG. 4A are provided as an example, and a workload may be characterized by different sets of instruction classes, a different number of instruction classes, or different weights.

As a second example of a workload characterization, consider an instruction mix with spatial coverage characterization of a workload, based on usage of respective components across the platform. Platform-level spatial coverage includes components of the processor, such as IP block coverage that characterizes which microarchitectural blocks within the processor (or cores) are exercised by a workload and the relative extent of their usage. Platform-level spatial coverage also includes processor uncores, which contain much information on the non-core related state and configuration.

Platform-level spatial coverage also includes non-CPU components of a platform, including memory, xPU silicon, BIOS, IO/CXL devices, and other components, to provide a detailed picture of the activities of the workload being profiled throughout the computer system. All this data in combination provides a spatial view of workload behavior, mapping software execution to the physical structures that implement it.

FIG. 4B illustrates a heatmap 420 of an example IP block coverage representing spatial utilization observed during a workload profiling window. This heatmap characterizes which microarchitectural blocks and platform components within a system are exercised by a workload and the relative extent of their usage. In FIG. 4B, the IP block coverage is depicted as a set of regions, each region corresponding to a component and each region associated with a normalized utilization weight in a range of 0 to 1. As shown, the weight is represented in the heatmap 420 by a color (or shading) value mapped along a scale extending from a low utilization value of 0 to a high utilization value of 1. The particular components and weights depicted in FIG. 4B are provided as an example, and in other examples, a workload may be characterized by a different set of components, a different number of components, or different weights.

The IP block coverage provides a spatial view of workload behavior in which software execution is mapped to the physical structures within the system that implement it. As non-limiting examples, the IP block coverage includes a region corresponding to instruction fetch and decode, a region corresponding to a branch predictor, a region corresponding to an arithmetic logic unit (ALU), a region corresponding to a floating point unit (FPU), and a region corresponding to a vector unit, depicted as supporting AVX and AMX operations, and weights associated with these respective regions.

The IP block coverage also includes regions corresponding to a cache hierarchy, including a level one instruction cache (L1I cache), a level one data cache (L1D cache), a level two cache (L2 cache), and a shared level three cache (L3 cache), with varying utilization weights for each unit. The IP block coverage also includes regions corresponding to components outside the core, including an interconnect, a DDR memory controller, a PCIe interface, and a CXL interface, each associated with respective utilization weights.

In some examples, the IP block coverage is collected during execution of a workload and is used to generate a portion of a workload embedding using a workload characterizer. Additionally, the weights of the IP block coverage may be subsequently used by a test selector to allocate screening effort among the components, so that a greater amount of screening effort is directed toward components associated with higher weights. In the depicted example, this would mean that additional screening effort is focused on the vector unit, the L1 data cache, and the DDR memory controller, and a lesser amount of screening effort is provided on the components associated with lower weights.

As a third example, consider an instruction mix with execution-driven operating conditions (e.g., temporal and telemetry conditions), based on usage across the platform. The execution-driven conditions can capture how workloads exercise the processing units over time and the resulting operating conditions induced by that behavior, including utilization dynamics, duty cycle, burstiness, the sequence and ordering of microarchitectural operations, and the associated voltage, frequency, temperature, and power responses. This characterization describes the dynamic operating envelope experienced by the silicon during real customer workloads, accounting for both instantaneous behavior and operation sequencing effects, rather than static worst-case limits.

In further examples, additional adaptation and profiling may occur during the workload execution. Consider a scenario where a workload is planned to be executed, and the microarchitecture coverage of the workload is to be profiled during the workload execution. Depending on the needs of the workload, a profiler process can perform initialization operations, such as pinning the workload to a specific LPU (logical processing unit) or performing an initial inspection of the workload binary and its initial process state. Once this baseline information is collected, the profiler process will subscribe to or otherwise monitor events provided by the kernel and its interfaces to characterize the activities of the workload. The workload is then allowed to begin its execution, and the resulting profiling information is used to shape the subsequent test workload.

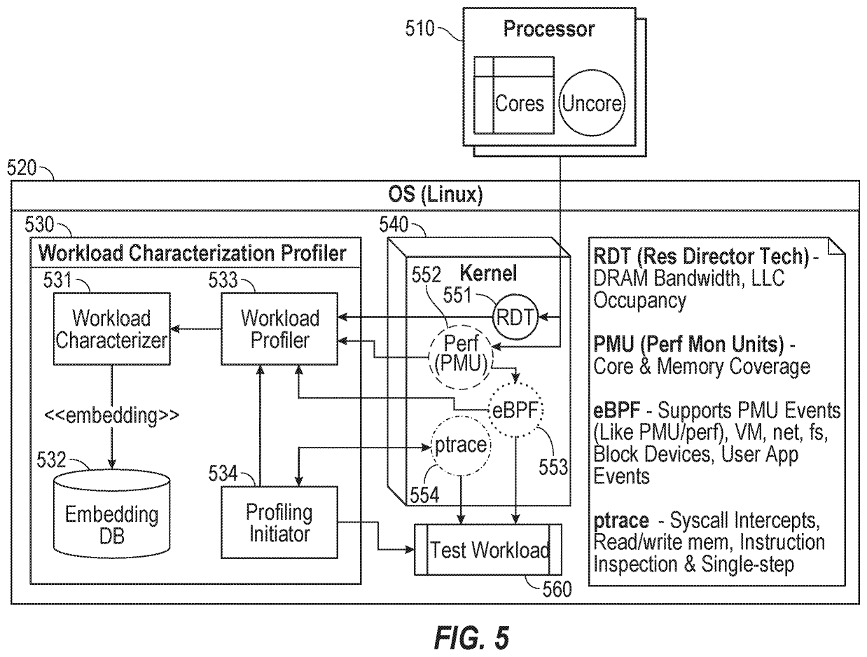

FIG. 5 illustrates a component diagram of an example workload profiling arrangement implemented within a system. The arrangement is depicted with respect to a processor 510 and an operating system 520 executing on this processor. This arrangement also shows components that collect telemetry from the processor 510 during execution of a workload, including transforming the collected telemetry into a workload embedding as discussed above.

In this example, the processor 510 includes one or more cores and an uncore. The cores execute instructions of a workload, and the uncore contains the state and the configuration of the processor 510 that is outside of the cores. The processor 510 is monitored by components provided within the operating system 520, depicted as a Linux operating system, during execution of a specific workload.

A workload characterization profiler 530 operates within the operating system 520 and collects telemetry from the processor 510. The workload characterization profiler 530 includes a workload characterizer 531, an embedding database 532, a workload profiler 533, and a profiling initiator 534. The profiling initiator 534 initiates the profiling of a specific workload (a test workload 560) and coordinates various types of event tracing with the specific workload.

In an example, the workload profiler 533 collects telemetry describing execution of the test workload 560 and provides the collected telemetry to the workload characterizer 531. The workload characterizer 531 distills the collected telemetry into a workload embedding, and stores the workload embedding in the embedding database 532.

The workload profiler 533 collects telemetry from a set of telemetry sources accessible through a kernel 540 of the operating system 520. As non-limiting examples, the kernel 540 provides interfaces to a resource director technology (RDT) component 551, a performance monitoring component 552, an extended Berkeley packet filter (eBPF) component 553, and a process trace component 554. The resource director technology component 551 reports memory bandwidth and last-level cache occupancy. The performance monitoring component 552 reports core and memory coverage from performance monitoring units of the processor 510. The extended Berkeley packet filter component 553 collects events including performance monitoring events, virtual machine events, network events, filesystem events, block device events, and user application events. The process trace component 554 intercepts system calls, reads program registers and memory, and performs instruction inspection and single-operation control of execution.

The test workload 560 then executes within the operating system 520 and is observed by the workload characterization profiler 530 and its sub-components described above. In some examples, the test workload 560 is a live customer workload, whereas in other examples, the test workload 560 is a screening test whose hardware coverage is profiled. The test workload 560 then executes as normal until its final state, where profiling will end, a final snapshot of process information is collected, and any cleanup is performed to release kernel or processor-level resources.

Metadata may include hardware versions, firmware versions, software versions, and other configuration information, which may be captured in addition to profiling data. This metadata can assist in a characterization of the workload to generate embeddings that are comparable. This metadata also allows workload profiling to be performed on one or a few systems as a representative sample, rather than needing to profile every system in an overall cluster.

After workload profiling completes, the collected data is characterized into a compact workload profile suitable for reuse, comparison, and screening decision-making. This stage converts detailed observations, such as instruction mix, spatial coverage, and execution-driven operating behavior, into a normalized representation of how the hardware is exercised.

In some examples, workload profiles are established as embeddings. The characterization process distills raw workload data into compact signatures (embeddings) that represent hardware usage patterns rather than software implementation details. These embeddings capture the relative emphasis of instructions, microarchitectural blocks, and operating regimes observed during execution, while discarding information that could expose proprietary code or algorithms. The resulting workload embedding serves as a stable, reusable fingerprint of hardware behavior that can be stored (in an Embedding DB such as embedding database 532), compared, and applied across screening engagements.

Once characterized, workload embeddings can be compared to assess behavioral similarity, such as using similarity search techniques. Workloads with similar embeddings are inferred to exercise the processor in comparable ways and can therefore share common screening strategies. This enables new or previously unseen workloads to be mapped to existing screening profiles based on similarity, avoiding the need to design or execute unique screening flows for every workload instance.

The characterization process supports multiple levels of workload characterization fidelity, such as in a full characterization embedding versus a quantized workload characterization embedding. As a first example, a full characterization embedding, retained locally in a private customer embeddings database, will include higher-resolution workload characterization data used to guide fine-grained screening behavior. As a second example, an abstracted or quantized characterization, derived from the full characterization, may leave the private customer boundary. A reduced fidelity characterization preserves the essential hardware usage signature while minimizing detail, enabling aggregation, comparison, and reuse without exposing proprietary workload information. This may include the use of a text-based format (e.g., which offers an opportunity for the customer to inspect data before any data leaves the customer environment/customer datacenter boundary). This separation allows detailed workload awareness to inform screening locally, while only compact, IP-safe workload fingerprints are shared more broadly.

In a further example, a test harness is configured to ingest a workload embedding and use the workload embedding to drive screening decisions across multiple axes. A first axis used by the test harness can include test selection considerations. For instance, the instruction mix weights, discussed with reference to FIG. 4A above, identify which instruction classes (e.g., AVX512, AMX, branch-heavy, load/store-intensive) dominate the workload. The test harness can be configured to prioritize test content that exercises those instruction categories proportionally, increasing coverage of heavily-used paths and deprioritizing rarely-exercised ones.

A second axis used by the test harness can include IP block targeting. The core IP block utilization weights, discussed with reference to FIG. 4B above, direct screening effort toward the microarchitectural structures that are most exercised by the workload. This can be used to allocate more stress time to high-weight blocks (e.g., vector units, L1D cache) and reduce time spent on low-weight blocks (e.g., CXL, PCIe), effectively translating the spatial heat map into a weighted screening schedule.

A third axis used by the test harness can include operating condition tuning. The temporal profile (e.g., utilization dynamics, duty cycle, burstiness, sequences) and telemetry envelope (e.g., voltage, frequency, temperature, power ranges) inform the test harness how to configure screening conditions. This results in setting voltage/frequency targets, thermal profiles, and stress duty cycles that replicate the dynamic operating envelope observed during the real workload, rather than defaulting to static worst-case corners.

When a new or previously unseen workload embedding is presented, the harness can compare it against existing embeddings by similarity and map it to the nearest known screening profile, avoiding the need to design a unique screening flow for every workload instance.

In many of the scenarios above, workload embeddings can be maintained within customer environments. However, due to their anonymized or abstracted nature, these workload embeddings may also be shared externally (e.g., to a manufacturer) to enable a feedback loop that improves the screening tools used by manufacturers and related parties during production. As one example, a centralized embeddings database can aggregate anonymized workload embeddings from multiple customers and deployment environments, providing broader visibility into real-world execution regimes without exposing proprietary workload details from individual customers or deployments. Similarity analysis can be deployed across this aggregated embedding corpus, to support the refinement and evolution of workload-informed screening strategies, and to enable more effective future screening tools while preserving customer privacy and intellectual property boundaries.

Additionally, as an extension of the approaches, for parties requiring extreme anonymization measures, a workload embedding may be further transformed through a controlled quantization or abstraction operation prior to storage, sharing, or comparison. This secondary transformation intentionally reduces embedding precision by collapsing fine-grained execution distinctions, while preserving the coarse geometric structure required for a similarity-based analysis. The resulting quantized embedding provides an additional layer of anonymization beyond the initial embedding generation, to help prevent any reconstruction or inference of proprietary execution details. However, a quantized embedding still enables an approximate determination of whether a partial or subsequent execution is consistent with, or covered by, the execution characteristics of a larger workload profile. Similarity operations performed in this quantized embedding space therefore operate on abstract execution regimes rather than exact execution patterns, balancing enhanced privacy protection with sufficient utility for coverage inference and screening decisions.

The examples presented above for workload characterization can be extended beyond a single system to a cluster level or other multi-system group. A workload running across many systems could be characterized using the same approaches mentioned above with a larger scope.

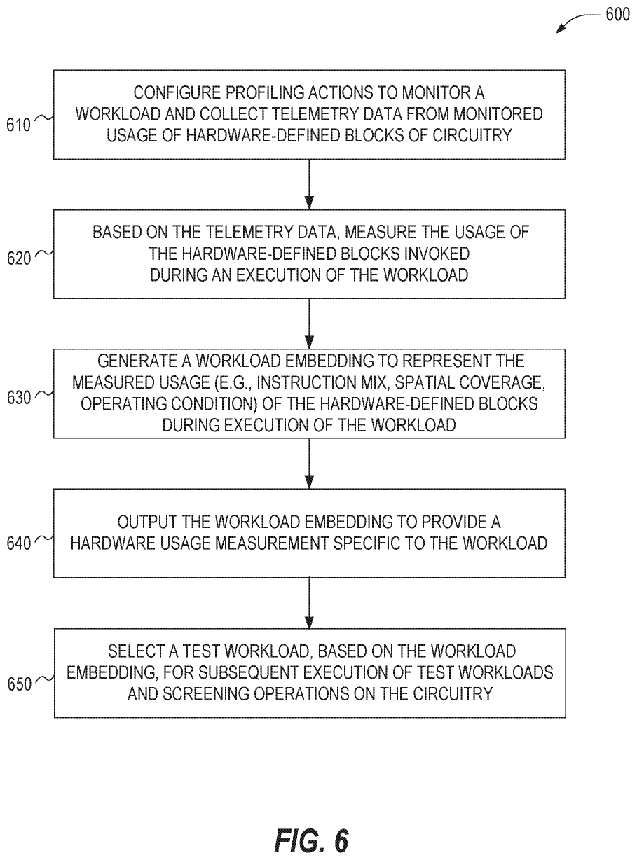

FIG. 6 illustrates a flowchart 600 of an example method of generating a workload embedding and selecting a test workload. The method may be performed by a computing system under test, such as a customer or manufacturer computing system comprising circuitry that includes hardware-defined blocks and a memory device that includes instructions which, when executed by the circuitry, configure the circuitry to perform the operations described below. The method may also be performed by circuitry (e.g., a processor) of a computer system that monitors circuitry in another computer system under test. These hardware-defined blocks may be provided from a combination of IP blocks, processor cores, or processor uncore units discussed above. In some examples, the circuitry comprises a central processing unit (CPU), a graphics processing unit (GPU), a system-on-chip, or a system-in-package semiconductor device.

At operation 610, the method configures profiling actions to monitor a workload, including profiling actions that collect telemetry data from monitoring usage of the hardware-defined blocks of the circuitry. These profiling actions may correspond to the configuration of telemetry sources described above (e.g., in operation 210 of FIG. 2 or the monitoring components of FIG. 5), which respectively collect telemetry data from the circuitry during execution of a workload. The monitored workload, in some examples, may include confidential (e.g., private customer) workload data.

At operation 620, the method measures the usage of the hardware-defined blocks invoked during an execution of the workload on the circuitry, based on the telemetry data produced by the profiling actions. This measurement may correspond to the profiling discussed above (e.g., in operations 221, 222, and 223 of FIG. 2), and may include one or more of the following examples. In a first example, operation 620 measures an instruction mix, used in at least one instruction unit of the circuitry during the execution of the workload, such as described above with respect to FIG. 4A. In a second example, operation 620 measures a spatial coverage of respective IP blocks of the circuitry, used during the execution of the workload, such as described above with respect to FIG. 4B. In some examples, operation 620 measures execution-driven operating conditions, during the execution of the workload, such as from a sequence of how the execution of the workload uses the hardware-defined blocks. As discussed above, such execution-driven operating conditions may include utilization dynamics, duty cycle, burstiness, sequencing of operations, and associated voltage, frequency, temperature, and power responses.

At operation 630, the method generates a workload embedding to represent the measured usage of the hardware-defined blocks during the execution of the workload. This generation of the workload embedding may correspond to the workload characterization described above (e.g., in operation 240 of FIG. 2 and the workload characterizer 531 of FIG. 5). In some examples, the workload embedding includes feature-weight pairs that represent respective amounts of the usage of the hardware-defined blocks during the execution of the workload. These feature-weight pairs can include the normalized weights described above with respect to an instruction mix or an IP block coverage. Although the workload being executed may include confidential workload data, the workload embedding provides a summary of an amount of the usage of individual blocks of the hardware-defined blocks that were used to process the confidential workload data during the execution of the workload, without revealing the confidential workload data itself.

At operation 640, the method includes outputting the workload embedding to provide a hardware usage measurement specific to the workload, which in turn is used to guide a test of the hardware-defined blocks of the circuitry. This operation may include storing the workload embedding in a workload embedding database that is maintained in a private environment (e.g., a workload embedding database corresponding to the embedding database 532 of FIG. 5 or the workload embedding database 360A of FIG. 3 located within the customer datacenter boundary). In some examples, a quantized characterization of the workload embedding is generated and provided, such as to be stored in an external workload embedding database that is maintained outside the private environment (e.g., a workload embedding database corresponding to the workload embedding database 360B of FIG. 3 located outside the customer datacenter boundary). The quantized characterization can provide an abstracted form of the workload embedding that preserves the hardware usage signature while reducing detail, as described above.

At operation 650, the method includes selecting a test workload, based on the workload embedding, for subsequent execution of test workloads and screening operations on the circuitry. This selection may correspond to the test selection described above (e.g., in operation 250 of FIG. 2, or the test selectors 370A and 370B of FIG. 3). The test workload may be selected to invoke a subset of the hardware-defined blocks of the circuitry that corresponds to the hardware-defined blocks invoked by the workload. In some examples, the test workload implements at least one of a plurality of stress tests designated for the subset of the hardware-defined blocks in connection with the screening operations, and the plurality of stress tests includes targeted operations that repeat the usage of the subset of the hardware-defined blocks. In some examples, the selection of the test workload is based on a similarity between the workload embedding and a second workload embedding associated with the test workload, such as produced by a similarity search.

In some examples, this second workload embedding associated with the test workload is generated by applying the operations described above to the test workload, to profile and generate a hardware usage measurement specific to the test workload. In such examples, the method includes second profiling actions to monitor the test workload, and collect second telemetry data from monitoring the usage of the hardware-defined blocks of the circuitry (e.g., the hardware-defined blocks invoked during an execution of the test workload on the circuitry). The method then generates the second workload embedding to represent the measured usage of the hardware-defined blocks during the execution of the test workload. This profiling of the test workload corresponds to the profiling of a screening test described above (e.g., in operation 220 of FIG. 2 and the test workload 560 of FIG. 5). The resulting second workload embedding can be used to perform a comparison of how the test workload exercises the hardware-defined blocks, versus the manner in which a customer workload exercises the hardware-defined blocks.

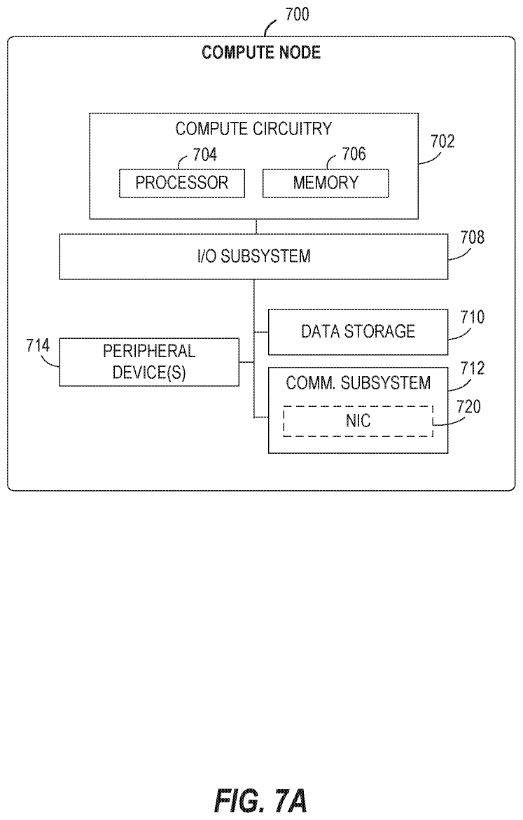

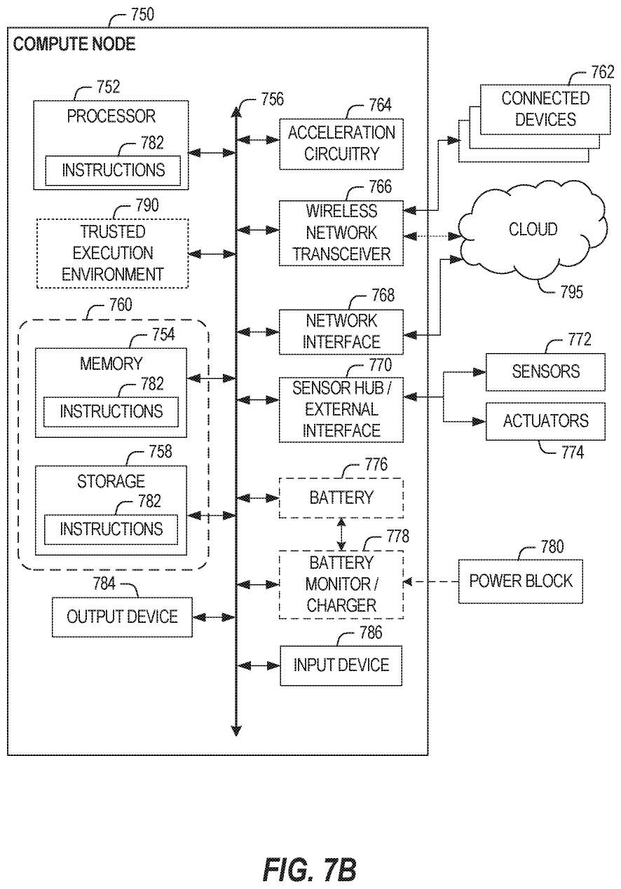

Any of the computing nodes or devices used to implement the aforementioned techniques may be implemented based on the components of a compute node as depicted in FIGS. 7A and 7B. Respective compute nodes may be embodied as a type of device, appliance, computer, or other “thing” capable of communicating with other edge, networking, or endpoint components. For example, a compute device may be embodied as a robot, a robot control system, a personal computer, a server, a mobile computing device, a smart appliance, an in-vehicle compute system (e.g., a navigation system), a self-contained device having an outer case, shell, etc., or other device or system capable of performing the described functions.

In the simplified example depicted in FIG. 7A, a compute node 700 includes a compute engine (also referred to herein as “compute circuitry”) 702, an input/output (I/O) subsystem 708, a data storage device 710, a communication circuitry 712 subsystem, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special-purpose processing unit, or other processor or processing/controlling circuit.

In some examples, the processor 704 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that an xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation, such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data, such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems, depending on, for example, the type of compute node 700.

The communication circuitry 712 may be embodied as any communication circuit, device, or collection thereof, capable of enabling communications over a network between the compute circuitry 702 and another compute device (e.g., a gateway of an implementing computing system). The communication circuitry 712 may be configured to use one or more communication technologies (e.g., wired or wireless communications) and associated protocols (e.g., a cellular networking protocol such as a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., a gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, or other levels.

Additionally, in some examples, a respective compute node 700 may include one or more peripheral devices 714. Such peripheral devices 714 may include any type of peripheral device found in a compute device or server, such as audio input devices, a display, other input/output devices, interface devices, and/or other peripheral devices, depending on the particular type of the compute node 700. In further examples, the compute node 700 may be embodied by a respective compute node (whether a client, gateway, or aggregation node) in a computing system or like forms of appliances, computers, subsystems, circuitry, or other components.

In a more detailed example, FIG. 7B illustrates a block diagram of an example of components that may be present in a computing node 750 for implementing the techniques (e.g., operations, processes, methods, and methodologies) described herein. This computing node 750 provides a closer view of the respective components of node 700 when implemented as or as part of a computing device (e.g., as a mobile device, a base station, server, gateway, etc.). The computing node 750 may include any combinations of the hardware or logical components referenced herein, and it may include or couple with any device usable with a communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the computing node 750, or as components otherwise incorporated within a chassis of a larger system.

The computing node 750 may include processing circuitry in the form of a processor 752, which may be a microprocessor, a multi-core processor, a multithreaded processor, an ultra-low voltage processor, an embedded processor, an xPU/DPU/IPU/NPU, special-purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, California. As an example, the processor 752 may include an Intel® Architecture Core™ based CPU processor, such as a Quark™, an Atom™, an i3, an i5, an i7, an i9, or an MCU-class processor, or another such processor available from Intel®. However, any number of other processors may be used, such as those available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd., or a customer thereof, or their licensees or adopters. The processors may include units such as an A5-A19 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types, such as single die package (SDP), dual die package (DDP), or quad die package (QDP). These devices, in some examples, may be directly soldered onto a motherboard to provide a lower profile solution, while in other examples, the devices are configured as one or more memory modules that in turn couple to the motherboard by a given connector. Any number of other memory implementations may be used, such as other types of memory modules, e.g., dual inline memory modules (DIMMs) of different varieties, including but not limited to microDIMMs or MiniDIMMs.

To provide for persistent storage of information, such as data, applications, operating systems, and so forth, a storage 758 may also be coupled to the processor 752 via the interconnect 756. In an example, the storage 758 may be implemented via a solid-state disk drive (SSD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low-power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such as resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI Express (PCIe), or any number of other technologies. The interconnect 756 may be a proprietary bus, for example, used in an SoC-based system. Other bus systems may be included, such as an Inter-Integrated Circuit (I2C) interface, a Serial Peripheral Interface (SPI) interface, point-to-point interfaces, and a power bus, among others.

The interconnect 756 may couple the processor 752 to a transceiver 766, for communications with the connected devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at different ranges. For example, the computing node 750 may communicate with close devices, e.g., within about 7 meters, using a local transceiver based on Bluetooth Low Energy (BLE), or another low-power radio, to save power. More distant connected devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the cloud 795 via local or wide area network protocols. The wireless network transceiver 766 may be a low-power wide-area (LPWA) transceiver that follows the IEEE 802.15.4, or IEEE 802.15.4g standards, among others. The computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low-bandwidth communications, such as Sigfox, and other technologies. Further, other communications techniques, such as time-slotted channel hopping, described in the IEEE 802.15.4e specification, may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium-speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the cloud 795 or to other devices, such as the connected devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components (circuitry 764, transceiver 766, NIC 768, or interface 770). Accordingly, in various examples, applicable means for communicating (e.g., receiving, transmitting, etc.) may be embodied by such communications circuitry.

The computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the computing node 750 to actuators 774, such as power switches, valve actuators, an audible sound generator, a visual warning device, and the like.

In some optional examples, various input/output (I/O) devices may be present within or connected to the computing node 750. For example, a display or other output device 784 may be included to show information, such as sensor readings or actuator position. An input device 786, such as a touch screen or keypad, may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing node 750. A display or console hardware, in the context of the present system, may be used to provide output and receive input of a computing system; to manage components or services of a computing system; identify a state of a computing component or service; or to conduct any other number of management or administration functions or service use cases.

A battery 776 may power the computing node 750, although, in examples in which the computing node 750 is mounted in a fixed location, it may have a power supply coupled to an electrical grid, or the battery may be used as a backup or for temporary capabilities. The battery 776 may be a lithium-ion battery, or a metal-air battery, such as a zinc-air battery, an aluminum-air battery, a lithium-air battery, and the like.

A battery monitor/charger 778 may be included in the computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix, Arizona, or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application-specific integrated circuit (ASIC).

In an example, the instructions 782 provided via the memory 754, the storage 758, or the processor 752 may be embodied as a non-transitory, machine-readable medium 760 (also referred to as a device-readable medium or storage medium) including code to direct the processor 752 to perform electronic operations in the computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine-readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the computing node 750 through the TEE 790 and the processor 752.

In further examples, a machine-readable medium also includes any tangible medium that is capable of storing, encoding, or carrying instructions for execution by a machine and that causes the machine to perform any one or more of the methodologies of the present disclosure or that is capable of storing, encoding, or carrying data structures utilized by or associated with such instructions. A “machine-readable medium” thus may include, but is not limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus that is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, decrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations that, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations, including over different storage devices, and may exist, at least partially, merely as electronic signals on a system or network. The components or modules may be passive or active, including agents operable to perform desired functions.

Additional examples of the presently described method, system, and device embodiments include the following non-limiting implementations provided in the claims and/or drawings. Each of the following non-limiting examples may stand on its own or may be combined in any permutation or combination with any one or more of the other examples provided below or throughout the present disclosure.
Example 1 is a method performed with a plurality of operations executed with circuitry of a computing system, the method comprising: configuring profiling actions to monitor a workload in the computing system, the profiling actions to collect telemetry data from monitoring usage of hardware-defined blocks of the circuitry; and based on the telemetry data, providing a hardware usage measurement specific to the workload to guide a test of the hardware-defined blocks of the circuitry.
In Example 2, the subject matter of Example 1 optionally includes measuring the usage of the hardware-defined blocks invoked during an execution of the workload on the circuitry; generating a workload embedding, the workload embedding to represent the measured usage of the hardware-defined blocks during the execution of the workload; and outputting the workload embedding to represent the hardware usage measurement specific to the workload.
In Example 3, the subject matter of Examples 1 to 2 optionally includes selecting a test workload (e.g., based on the workload embedding) for subsequent execution of screening operations on the circuitry; wherein the test workload invokes a subset of the hardware-defined blocks of the circuitry that corresponds to the hardware-defined blocks invoked by the workload.
In Example 4, the subject matter of Example 3 optionally includes subject matter where the test workload implements at least one of a plurality of stress tests designated for the subset of the hardware-defined blocks, in connection with the screening operations on the circuitry, and optionally wherein the plurality of stress tests includes targeted operations that repeat the usage of the subset of the hardware-defined blocks.
In Example 5, the subject matter of any one or more of Examples 3-4 optionally includes subject matter where selecting the test workload is based on a similarity between the workload embedding (e.g., associated with the hardware usage measurement) and a second workload embedding (e.g., associated with the test workload).
In Example 6, the subject matter of Example 5 optionally includes: configuring second profiling actions to monitor the test workload, the second profiling actions to collect second telemetry data from monitoring the usage of the hardware-defined blocks of the circuitry; based on the second telemetry data, measuring the usage of the hardware-defined blocks invoked during an execution of the test workload on the circuitry; and optionally generating the second workload embedding, the second workload embedding to represent the measured usage of the hardware-defined blocks during the execution of the test workload.
In Example 7, the subject matter of any one or more of Examples 1-6 optionally includes subject matter where measuring the usage of the hardware-defined blocks includes: measuring an instruction mix, used during the execution of the workload, in at least one instruction unit of the circuitry; measuring a spatial coverage of respective IP blocks of the circuitry, used during the execution of the workload; or measuring execution-driven operating conditions, during the execution of the workload, from a sequence of how the execution of the workload uses the hardware-defined blocks.
In Example 8, the subject matter of any one or more of Examples 1-7 optionally includes: storing the workload embedding in a workload embedding database, wherein the workload embedding database is maintained in a private environment, and wherein the workload embedding includes feature-weight pairs that represent respective amounts of the usage of the hardware-defined blocks during the execution of the workload.
In Example 9, the subject matter of Example 8 optionally includes: generating a quantized characterization of the workload embedding; and providing the quantized characterization of the workload embedding to be stored in an external workload embedding database, wherein the external workload embedding database is maintained outside the private environment.
In Example 10, the subject matter of any one or more of Examples 1-9 optionally includes subject matter where the workload includes confidential workload data, and wherein a workload embedding is generated to provide a summary of an amount of the usage of individual blocks of the hardware-defined blocks used to process the confidential workload data during the execution of the workload, without revealing the confidential workload data.
In Example 11, the subject matter of any one or more of Examples 1-10 optionally includes subject matter where the hardware-defined blocks are provided from a combination of IP blocks, processor cores, or processor uncore units, and wherein the circuitry comprises a central processing unit (CPU), graphics processing unit (GPU), system-on-chip, or system-in-package semiconductor device.
Example 12 is a computing system under test, comprising: circuitry comprising hardware-defined blocks; and a memory device including instructions embodied thereon, wherein the instructions, which when executed by the circuitry, configure the circuitry to perform operations for generating, executing, or using a workload characterization from a workload embedding or other hardware usage measurement, in accordance with Examples 1 to 11 or other examples disclosed herein.
Example 13 is a method, comprising a plurality of operations executed with a processor and memory of a device, to perform operations for generating, executing, or using a workload characterization from a workload embedding or other hardware usage measurement, for circuitry of the same device or in another device, in accordance with Examples 1 to 11 or other examples disclosed herein.
Example 14 is a non-transitory machine-readable storage medium including and comprising instructions, wherein the instructions, when executed by a processor of a device, cause the processor to perform operations for generating, executing, or using a workload characterization from a workload embedding or other hardware usage measurement, for circuitry of the same device or in another device, in accordance with Examples 1 to 11 or other examples disclosed herein.
Example 15 is an apparatus, comprising respective means for generating, executing, or using a workload characterization from a workload embedding or other hardware usage measurement, for circuitry of the same device or in another device, in accordance with Examples 1 to 11 or other examples disclosed herein.
Example 16 is a network comprising respective devices and device communication mediums for performing any of the operations or techniques discussed herein, in accordance with Examples 1 to 11 or other examples disclosed herein.
Example 17 is a system comprising respective components arranged or configured to perform any of the operations or techniques discussed herein, in accordance with Examples 1 to 16 or other examples disclosed herein.
Example 18 is a method, performed using circuitry of a computing device, arranged or configured to perform any of the operations or techniques discussed herein, in accordance with Examples 1 to 16 or other examples disclosed herein.

Although these implementations have been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read-only memories (ROMs), and the like.

What is claimed is:

1. A computing system under test, comprising:
circuitry comprising hardware-defined blocks; and
a memory device including instructions embodied thereon, wherein the instructions, which when executed by the circuitry, configure the circuitry to perform operations that:
configure profiling actions to monitor a workload, the profiling actions to collect telemetry data from monitoring usage of the hardware-defined blocks of the circuitry; and
based on the telemetry data, provide a hardware usage measurement specific to the workload to guide a test of the hardware-defined blocks of the circuitry.

2. The computing system of claim 1, wherein the instructions further configure the circuitry to perform operations that:
measure the usage of the hardware-defined blocks invoked during an execution of the workload on the circuitry;
generate a workload embedding, the workload embedding to represent the measured usage of the hardware-defined blocks during the execution of the workload; and
output the workload embedding to represent the hardware usage measurement specific to the workload.

3. The computing system of claim 2, wherein the instructions further configure the circuitry to perform operations that:
store the workload embedding in a workload embedding database, wherein the workload embedding database is maintained in a private environment, and wherein the workload embedding includes feature-weight pairs that represent respective amounts of the usage of the hardware-defined blocks during the execution of the workload.

4. The computing system of claim 2, wherein the workload includes confidential workload data, and wherein the workload embedding provides a summary of an amount of the usage of individual blocks of the hardware-defined blocks used to process the confidential workload data during the execution of the workload, without revealing the confidential workload data.

5. The computing system of claim 1, wherein the instructions further configure the circuitry to perform operations that:
select a test workload for subsequent execution of screening operations on the circuitry;
wherein the test workload invokes a subset of the hardware-defined blocks of the circuitry that corresponds to the hardware-defined blocks invoked by the workload.

6. The computing system of claim 5, wherein the test workload implements at least one of a plurality of stress tests designated for the subset of the hardware-defined blocks, in connection with the screening operations on the circuitry.

7. The computing system of claim 5, wherein the operations that select the test workload are based on a similarity between a workload embedding associated with the hardware usage measurement and a second workload embedding associated with the test workload.

8. The computing system of claim 5, wherein the instructions further configure the circuitry to perform operations that:
configure second profiling actions to monitor the test workload, the second profiling actions to collect second telemetry data from monitoring the usage of the hardware-defined blocks of the circuitry;
based on the second telemetry data, measure the usage of the hardware-defined blocks invoked during an execution of the test workload on the circuitry.

9. The computing system of claim 1, wherein the operations that measure the usage of the hardware-defined blocks include operations that perform at least one of:
measure an instruction mix, used during the execution of the workload, in at least one instruction unit of the circuitry;
measure a spatial coverage of respective IP blocks of the circuitry, used during the execution of the workload; or
measure execution-driven operating conditions, during the execution of the workload, from a sequence of how the execution of the workload uses the hardware-defined blocks.

10. The computing system of claim 1, wherein the hardware-defined blocks are provided from a combination of IP blocks, processor cores, or processor uncore units, and wherein the circuitry comprises a central processing unit (CPU), graphics processing unit (GPU), system-on-chip, or system-in-package semiconductor device.

11. A non-transitory machine-readable storage medium comprising instructions that, when executed by a processor of a computing system, cause the processor to perform operations that:
configure profiling actions to monitor a workload executing on circuitry, the profiling actions to collect telemetry data from monitoring usage of hardware-defined blocks of the circuitry in the computing system or in another computing system; and
based on the telemetry data, provide a hardware usage measurement specific to the workload to guide a test of the hardware-defined blocks of the circuitry.

12. The non-transitory machine-readable storage medium of claim 11, wherein the instructions further cause the processor to perform operations that:
measure the usage of the hardware-defined blocks invoked during an execution of the workload on the circuitry;
generate a workload embedding, the workload embedding to represent the measured usage of the hardware-defined blocks during the execution of the workload; and
output the workload embedding to represent the hardware usage measurement specific to the workload.

13. The non-transitory machine-readable storage medium of claim 11, wherein the instructions further cause the processor to perform operations that:
select a test workload for subsequent execution of screening operations on the circuitry;
wherein the test workload invokes a subset of the hardware-defined blocks of the circuitry that corresponds to the hardware-defined blocks invoked by the workload; and
wherein the test workload implements at least one of a plurality of stress tests designated on the subset of the hardware-defined blocks, in connection with the screening operations on the circuitry.

14. The non-transitory machine-readable storage medium of claim 11, wherein the instructions further configure the processor to perform operations that:
configure second profiling actions to monitor a test workload, the second profiling actions to collect second telemetry data from monitoring the usage of the hardware-defined blocks of the circuitry; and
based on the second telemetry data, measure the usage of the hardware-defined blocks invoked during an execution of the test workload on the circuitry.

15. The non-transitory machine-readable storage medium of claim 11, wherein the operations that measure the usage of the hardware-defined blocks include operations from one or more of:
measure an instruction mix, used during the execution of the workload, in at least one instruction unit of the circuitry;
measure a spatial coverage of respective IP blocks of the circuitry, used during the execution of the workload; or
measure execution-driven operating conditions, during the execution of the workload, from a sequence of how the execution of the workload uses the hardware-defined blocks.

16. A method performed by a computing system, comprising:
configuring profiling actions to monitor a workload executing on circuitry, the profiling actions to collect telemetry data from monitoring usage of hardware-defined blocks of the circuitry in the computing system or in another computing system; and
based on the telemetry data, providing a hardware usage measurement specific to the workload.

17. The method of claim 16, further comprising:
measuring the usage of the hardware-defined blocks invoked during an execution of the workload on the circuitry;
generating a workload embedding, the workload embedding to represent the measured usage of the hardware-defined blocks during the execution of the workload; and
outputting the workload embedding to represent the hardware usage measurement specific to the workload.

18. The method of claim 16, further comprising:
selecting a test workload for subsequent execution of screening operations on the circuitry;
wherein the test workload invokes a subset of the hardware-defined blocks of the circuitry that corresponds to the hardware-defined blocks invoked by the workload; and
wherein the test workload implements at least one of a plurality of stress tests designated on the subset of the hardware-defined blocks, in connection with the screening operations on the circuitry.

19. The method of claim 16, further comprising:
configuring second profiling actions to monitor a test workload, the second profiling actions to collect second telemetry data from monitoring the usage of the hardware-defined blocks of the circuitry; and
based on the second telemetry data, measuring the usage of the hardware-defined blocks invoked during an execution of the test workload on the circuitry.

20. The method of claim 16, wherein measuring the usage of the hardware-defined blocks includes one or more of:
measuring an instruction mix, used during the execution of the workload, in at least one instruction unit of the circuitry;
measuring a spatial coverage of respective IP blocks of the circuitry, used during the execution of the workload; or
measuring execution-driven operating conditions, during the execution of the workload, from a sequence of how the execution of the workload uses the hardware-defined blocks.
